(19) United States
(12) Patent Application Publication
(10) Pub. No.: US 2016/0289480 A1
(43) Pub. Date: Oct. 6, 2016

(54) ANTIMICROBIAL CHALK COMPOSITIONS

(71) Applicant: Hand Armor Liquid Chalk LLC, Highland, UT (US)

(72) Inventor: Anthony J. Maddalone, Draper, UT (US)

(21) Appl. No.: 15/090,037

(22) Filed: Apr. 4, 2016

Related U.S. Application Data
(60) Provisional application No. 62/142,945, filed on Apr. 3, 2015.

(51) Int. Cl. C09D 13/00; A01N 59/16; A01N 65/22; C09D 5/14; A01N 31/02

(52) U.S. Cl. CPC C09D 13/00; C09D 5/14; A01N 31/02; A01N 65/22; A01N 59/16

(57) ABSTRACT

An embodiment includes a composition. The composition is a mixture of a chalk component and a sanitizer component. The sanitizer component exhibits volatility resulting in evaporation of the sanitizer component from the composition following application of the composition to a surface. The chalk component is retained in the composition following evaporation of the sanitizer component.

### CROSS-REFERENCE TO RELATED APPLICATIONS

This application claims the benefit of and priority to U.S. Provisional Application No. 62/142,945 filed Apr. 3, 2015, which is incorporated herein by reference in its entirety.

### FIELD

Embodiments described herein are related to antimicrobial or anti-germ chalk compositions. In particular, some embodiments describe liquid chalk compositions with antimicrobial properties.

### BACKGROUND

Microbes such as bacteria, viruses, protists, etc. can be found on surfaces of many objects. Microbes are easily transferred from one person to the next through the contact with or exposure to the objects. One place in which this transfer of microbes occurs routinely is gyms, fitness facilities, and weight rooms. For example, in these fitness environments, an individual who is carrying a microbe may touch a dumbbell or another piece of fitness equipment. Another individual may be exposed to the microbes during a subsequent use of the dumbbell or the piece of fitness equipment.

In addition, in some fitness environments, chalk is used. The chalk may facilitate a particular grip or otherwise increase effectiveness during exercise. However, use of chalk may result in chalk dust that is introduced into the air of the fitness environment as well as a mess caused by spills, overuse, and the like.

The claimed subject matter is not limited to embodiments that solve any disadvantages or that operate only in environments such as those described above. This background is only provided to illustrate examples of where the present disclosure may be utilized.

### SUMMARY

An aspect is a composition that may include a mixture of a chalk component and a sanitizer component. The composition may further include an herbal extract, a pigment, a foaming agent, or some combination thereof. The ratio by weight between the chalk component and the sanitizer component may be in the range of 1:16 to 1:1, in the range of 1:10 to 1:4, or about 1:8. The viscosity of the composition may be higher than the viscosity of water. The sanitizer component exhibits volatility that may result in evaporation of the sanitizer component from the composition following application of the composition to a surface. In greater detail, the volatility may result in evaporation of the sanitizer component from the composition in less than about thirty seconds at ambient environmental conditions including about one atmosphere of pressure and about 21 degrees Celsius. The sanitizer component may exhibit anti-germ properties in an amount effective for reducing or eliminating germs on the surface to which the composition is applied. The sanitizer component may exhibit moisture absorption properties resulting in production of a cohesive effect upon absorbing moisture for promoting adherence between the composition and the surface. The sanitizer component may include an isopropyl alcohol solution. The isopropyl alcohol solution may include a concentration of isopropyl alcohol (CH₃CH(OH)CH₃) in a range of about 65% to about 75% or a concentration of isopropyl alcohol in the isopropyl alcohol solution may be about 70%. The chalk component may be retained in the composition following evaporation of the sanitizer component. The chalk component may include magnesium carbonate (MGCO₃) and may include a sanitizing agent such as silver. The herbal extract may exhibit sanitizing and cooling properties. In greater detail, the surface may include the skin of a user and the herbal extract may create a cooling sensation when applied to the surface. Additionally, the herbal extract may include an anti-germ property that further reduces germs on the surface. The herbal extract may be a peppermint extract. The pigment may be configured to change a color of the composition. The foaming agent configured to trap gas during application of the composition. The surface may include one or more of a bar, a dumbbell, a barbell, a portion of a body of a user, a glove, a baseball bat, a softball bat, a golf club, a rock, a kettlebell, a wrist strap, and skin of a user.

Another aspect is a method that may include administering a composition to a surface. The composition may include a mixture of a chalk component and a sanitizer component. The sanitizer component may include an isopropyl alcohol solution with a concentration of isopropyl alcohol (CH₃CH(OH)CH₃) in a range of about 65% to about 75%. The chalk component may include Magnesium carbonate (MGCO₃) and a sanitizing agent such as silver. The ratio by weight between the chalk component and the sanitizer component may be in the range of 1:16 to 1:1, the range of 1:10 to 1:4, or about 1:8. The method may include spreading the composition on some portion of the surface. In greater detail, the surface may include skin on a first hand of a user and the spreading the composition may include spreading the composition on some portion of the skin of the first hand and a second hand. The method may include absorbing moisture with the composition to create a cohesive effect between the skin and the chalk component. The method may include allowing the sanitizer component of the composition to evaporate from the surface leaving the chalk component adhered to the surface. The composition may further comprise an herbal extract. The herbal extract may have an anti-germ property and cooling property that creates a cooling sensation when applied to the skin or another surface.

Yet another aspect is a method of preparing a liquid chalk composition for application to a surface. The surface may include one or more of a bar, a dumbbell, a barbell, a glove, a baseball bat, a softball bat, a golf club, a rock, a kettlebell, a wrist strap, and a skin of a user. The method may include adding a chalk composition in a first quantity to a liquid antimicrobial component of a second quantity. The method may include crushing the chalk composition prior to adding the chalk composition. The liquid antimicrobial component may exhibit volatility that may result in evaporation of the liquid antimicrobial component following the application to the surface. The liquid antimicrobial component may include an isopropyl alcohol solution with a concentration of isopropyl alcohol in a range of about 65% to about 75%. The second quantity may be an amount effective for reducing or eliminating germs present on the surface following application of the liquid chalk composition to the surface. The liquid antimicrobial component may exhibit moisture absorption properties resulting in production of a cohesive effect upon absorbing moisture for promoting adherence between the composition and the surface. The chalk component may be retained in the composition following evaporation of the sanitizer component. The chalk compound may include magnesium carbonate. The ratio by weight between the chalk component and the sanitizer component is about 1:8. The method may include mixing the chalk component and the liquid antimicrobial component to provide a homogenous mixture substantially free of agglomerations of the chalk component. Mixing the liquid antimicrobial component may include blending the liquid antimicrobial component until the liquid chalk composition has a viscosity that is higher than water. The method may include adding an herbal extract in a third quantity to the liquid chalk composition. The herbal extract may have anti-germ properties and/or a cooling property that creates a cooling sensation when applied to a surface such as skin. The method may include adding a lotion and/or a fragrance. The method may include adding pigment. The pigment may change a color of the liquid chalk composition. The method may include adding a foaming agent to the liquid antimicrobial component. The foaming agent may be added in an amount effective for causing gas entrapment by the liquid chalk composition during application of the composition to the surface.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIGS. 1A-1E depict portions of an example administration process of an example liquid chalk composition;

FIG. 2 is a flowchart of an example method of administering a liquid chalk composition; and

FIG. 3 is a flowchart of an example method of preparing a liquid chalk composition,

all in accordance with at least one embodiment described herein.

### DETAILED DESCRIPTION OF SOME EXAMPLE EMBODIMENTS

Microbes as used in this disclosure may include bacteria, viruses, fungi, protozoa, and the like. Microbes can be found on many surfaces and are transferred from one individual to the next through contact with objects that are contaminated. In fitness environments such as gyms, fitness facilities, and weight rooms, individuals commonly contact multiple types of objects such as barbells, dumbbells, exercise machines, water fountains, sinks, doorknobs, etc. This contact can contaminate these objects and may result in the spread of microbes between individuals.

In addition, in the fitness environments, individuals often use powder chalks. Use of the powder chalks may result in chalk dust. Microbes may bind to particles in the chalk dust. The chalk dust may be inhaled by other individuals, get into the eyes of individuals, or land on the skin of individuals. The chalk dust may be harmful to the eyes and may accumulate in respiratory systems, which may cause physical harm. Additionally, the chalk dust may accumulate in the fitness environment extending potential for transfer of the microbes.

Accordingly, some embodiments described in this disclosure include antimicrobial chalk compositions. The antimicrobial chalk compositions include one or more components that include an antimicrobial property. As the antimicrobial chalk composition contacts surfaces, it reduces or eliminates the presence of microbes. The antimicrobial chalk compositions may thus reduce transfer of microbial spread between individuals. Inclusion of the components with the antimicrobial property in a chalk composition is particularly effective in fitness environments. Individuals who are present in the fitness environments often already use chalk. Thus, the individuals may, simply by habit, incorporate the antimicrobial chalk compositions into use.

Moreover, chalk is often used as an interface between the individuals and the fitness equipment where contamination exists. For example, individuals use chalk to assist in grip when using barbells. The contact between the individual and the barbell may result in contamination of the barbell. However, by incorporating the component with the antimicrobial property in the chalk, the contact that previously resulted in contamination or spread of microbes, may instead result in a reduction of microbes and prevent or reduce their spread.

Some embodiments may include a powder chalk composition. In the powder chalk composition, a sanitizing agent may be mixed or otherwise incorporated with a chalk component. For example, the sanitizing agent may include nanoparticles with antimicrobial properties such as nanoparticles of silver. The sanitizing agent may be mixed with the chalk component during manufacture of the chalk component such that the sanitizing agent is evenly or substantially evenly distributed in the chalk component. The sanitizer component may be mixed in a quantity sufficient to reduce or eliminate the presence of microbes on a surface to which the powder chalk composition is applied without interfering with the function of the chalk component. The powder chalk composition may be formed into loose chalk, chalk balls, or chalk blocks.

Some embodiments include a liquid chalk composition. The liquid chalk composition includes a mixture of a chalk component and a sanitizer component (also referred to as a liquid antimicrobial component). The sanitizer component includes an antimicrobial property. In some embodiments, the liquid chalk composition may include physical characteristics similar to a gel or a foam. For example, the liquid chalk composition may include a physical characteristic of being a liquid or fluid with a higher viscosity than the viscosity of water. The viscosity may enable the compound to be administered to an angled (e.g., about 10 to about 30 degrees from horizontal) surface and not run off the angled surface. In these and other embodiments, the liquid chalk composition may have physical characteristics similar to a lotion.

The sanitizer component may include a liquid or a fluid that is included in the liquid chalk composition or introduced during chemical process of manufacturing the chalk component. The sanitizer component may evaporates into the atmosphere. In particular, the sanitizer component exhibits volatility that results in evaporation of the sanitizer component from the liquid chalk composition following application of the composition to a surface. For example, the volatility may result in evaporation of the sanitizer component from the liquid chalk composition in less than about thirty seconds at ambient environmental conditions. Some example ambient environmental conditions might include a typical fitness environment ambient condition such as about one atmosphere of pressure and about 21 degrees Celsius (e.g., “room temperature”). It will be appreciated that at higher temperatures and lower pressures the sanitizer component evaporates more quickly while at lower temperatures and higher pressures, the sanitizer component evaporates more slowly.

Accordingly, the liquid chalk composition may be administered to a surface, such as the surface of an individual's hands, a bar, etc. When administered the liquid chalk composition may have a physical resemblance to a lotion. Before the sanitizer component evaporates, the compound may be spread over the surface. After the sanitizer component evaporates, the chalk component remains and sticks to the surface to which the liquid chalk composition is applied.

The sanitizer component exhibits antimicrobial properties in an amount effective for reducing or eliminating microbes on the surface to which the liquid chalk composition is applied. For example, the sanitizer component may include an alcohol such as isopropyl alcohol, methanol, ethanol, a rubbing alcohol, or an antimicrobial nanoparticle such as silver (e.g., in a solution). Alcohols and in particular isopropyl alcohol as well as some antimicrobial nanoparticles may help kill several types of microbes such as, H1N1, ringworm, impetigo, MRSA, Staph, Staph aureus, Strep pyogenes, E. coli, Salmonella typhosa, Pseudomonas species, hepatitis B, herpes, and influenza. Some of these microbes can be killed by the sanitizer component in less than about ten seconds.

For example, in some embodiments, the sanitizer component includes an isopropyl alcohol solution. The isopropyl alcohol solution includes isopropyl alcohol (chemically in some embodiments, CH₃CH(OH)CH₃). The isopropyl alcohol concentration in the isopropyl alcohol solution may vary. For example, in some embodiments, the isopropyl alcohol solution may be about 70% isopropyl alcohol. For instance, at about 70% isopropyl alcohol, oxygen from the atmosphere may be allowed to contact the microbes on a surface, which may increase effectiveness of the liquid chalk composition. Additionally, at about 70% the scent of the alcohol is less when compared to a higher concentration of isopropyl alcohol.

In other embodiments, other concentrations of isopropyl alcohol in the isopropyl alcohol solution may be used. For example, a concentration in a range of about 65% to about 75% may be used, a concentration in a range of about 68% to about 72% may be used, a concentration in a range of about 69% to about 71% may be used, a concentration of about 90% isopropyl alcohol may be used, or a concentration of about 80% isopropyl alcohol may be used.

Increase in the concentration of the isopropyl alcohol in the isopropyl alcohol solution increases the volatility of the liquid chalk composition and decreases an evaporation time. However, the increase in the concentration may result in dry skin of the users, which may cause discomfort, and also may result in a strong alcohol odor. In other embodiments, another antimicrobial solution may be used as the sanitizer component.

Additionally, the sanitizer component may exhibit moisture absorption properties. In particular, the liquid chalk composition may be applied to the skin of a user. The sanitizer component may exhibit moisture absorption properties when it comes in contact with the skin. The moisture absorption results in production of a cohesive effect, which promotes adherence between the liquid chalk composition and the surface.

The chalk component of the liquid chalk composition is in solution when the liquid chalk composition is fluid. After the sanitizer component evaporates from the surface, the chalk component is retained in the liquid chalk composition. For example, a user may apply the liquid chalk composition as a lotion or liquid. The user may spread the liquid chalk composition on the surface while the liquid chalk composition is in a liquid form. The user may then allow the sanitizer component to evaporate (less than 30 seconds). Following the evaporation, at least the chalk component is retained on the surface. The chalk component remaining on the surface can be used during a fitness activity in a similar way to powder chalks. However, the chalk component may be more evenly spread onto the surface due to its inclusion in the liquid chalk composition. In addition, because of the inclusion of the chalk compound in the liquid chalk composition, generation of chalk dust may be minimized or eliminated during the application process. Moreover, the application process kills a substantial portion of the microbes on the surface to which the liquid chalk composition is applied. In some embodiments, the chalk component includes magnesium carbonate (chemically, in some embodiments, MGCO₃). In other embodiments other chalk components may be used.

The liquid chalk composition may include about 4 ounces of the chalk component which may be powdered or crushed. The chalk component may be mixed with about 32 Fluid ounces of 70% isopropyl alcohol solution. The liquid chalk composition may be mixed until it is substantially free of any large chunks or agglomerations of the chalk component. In some embodiments, more than 4 ounces or less than 4 ounces may be used.

In some embodiments, the liquid chalk composition may comprise a mixture of the chalk component and the sanitizer component. The ratio by weight between the chalk component and the sanitizer component may be in the range of 1:16 to 1:1. Additionally or alternatively, the ratio by weight between the chalk component and the sanitizer component may be in the range of 1:10 to 1:4. Additionally or alternatively still, the ratio by weight between the chalk component and the sanitizer component is about 1:8.

These example embodiments enable a combination of a cleaning process with an efficient deposition process of the chalk component. Until the introduction of such embodiments, the cleaning process was considered separate from the deposition of the chalk component. Moreover, until the introduction of such embodiments, the chalk component may have been perceived as a substance that contributed to and promoted transfer of microbes. Introduction of the embodiments described herein have redefined perceptions of the chalk component and its application.

Some embodiments of the liquid chalk composition may only include the chalk component and the sanitizer component (e.g., 70% isopropyl alcohol solution). Some embodiments of the liquid chalk composition may include the chalk component, the sanitizer component, a sanitizing agent, or some combination thereof. Some embodiments of the liquid chalk composition may include the chalk component, the sanitizer component, and one or more of an herbal extract, a foaming sanitizer component, a propellant, a lotion, a fragrance, and a pigment.

The liquid chalk composition may include the sanitizing agent in addition to or in place of the sanitizer component. For instance, the sanitizing agent may include nanoparticles with antimicrobial properties such as nanoparticles of silver. The sanitizing agent may be mixed in the liquid chalk composition as a powder or may be made into the chalk component during manufacture. Additionally or alternatively, instead of the sanitizer component(s) described above, the liquid chalk composition may constitute the sanitizing agent in a solution.

Some embodiments of the liquid chalk composition may include the chalk component, the sanitizer component, and one or more of an herbal extract, a foaming sanitizer component, a propellant, a lotion, a fragrance, and a pigment.

The herbal extract may exhibit sanitizing and cooling properties. For example, the herbal extract may include an antimicrobial property that further reduces microbes on the surface to which the composition is applied. The cooling properties may be caused by interaction between the herbal extract and the skin of a user. For example, the herbal extract may interact with nerves in the skin that triggers a cooling sensation on the skin. Examples of the herbal extract may include a mint extract, a spearmint extract, or a peppermint extract, which may include mentha and piperita.

In some embodiments, the liquid chalk composition may include the chalk component, the sanitization component (e.g., 1:8 ratio by weight) and about 5 drops (0.008453506 fluid ounces) of peppermint extract (chemically in some embodiments, C₁OH₂OO₁). The chalk composition, the isopropyl alcohol solution (e.g., 70% concentration), and the peppermint extract may be blended until the composition is substantially free of any large chunks or agglomeration of the chalk component.

The foaming sanitizer component and/or the propellant may cause the composition to trap gas during its application to a surface. The lotion may accommodate for the any moisture absorption. The fragrance may provide a particular smell to the liquid chalk composition. The pigment may be configured to change a color of the composition. For instance, the pigment may change the color of the composition to blue, green, purple, yellow, orange, red, or brown. In some embodiments, the pigment may be included in the chalk component or may be an independent component.

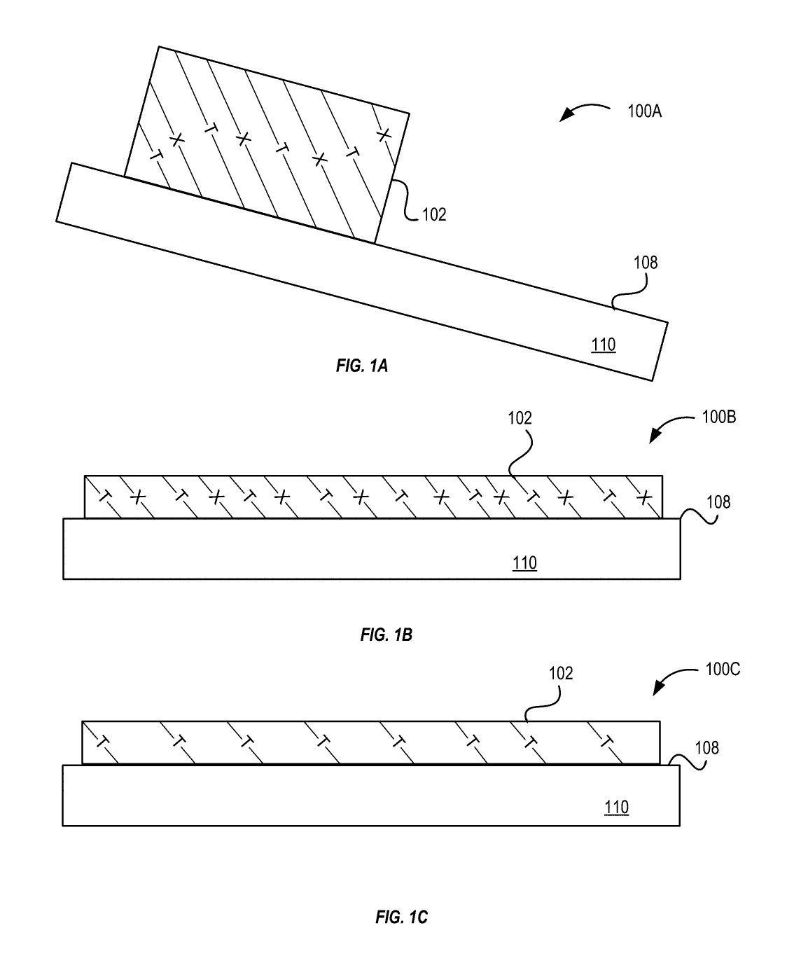

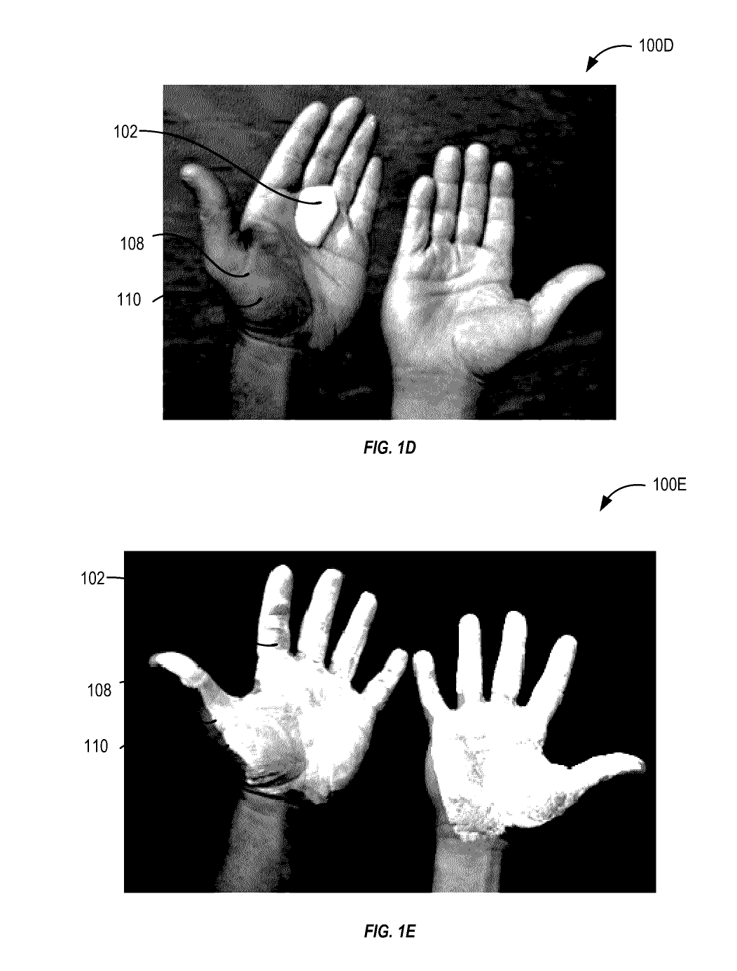

FIGS. 1A-1C are block diagrams and 1D and 1E are photographs that represent an example administration process of the liquid chalk composition 102. In a first diagram 100A, the liquid chalk composition 102 is administered to a surface 108 of an object 110. The liquid chalk composition 102 includes a chalk composition ‘T’ and a sanitization component ‘X’. The surface 108 is at an angle with respect to horizontal and the liquid chalk composition 102 does not completely run off the surface 108.

FIG. 1D is a photograph 100D that represents an example of the first diagram 100A of FIG. 1A. In the photograph 100D, the surface 108 is skin and the object is a hand 110 of a user. The liquid chalk composition 102 is administered to the skin 108 of the of hand 110. The liquid chalk composition 102 includes a chalk composition and a sanitization component. The hand 110 is at an angle with respect to horizontal and the liquid chalk composition 102 does not completely run off the skin 108.

FIG. 1B is a second diagram 100B illustrating a second step in an example administration process shown in FIGS. 1A-1C. In FIG. 1B, the liquid chalk composition 102 is applied to and spread on the surface 108 of the object 110. The liquid chalk composition 102 is not “rubbed into” the surface 108, just spread out.

FIG. 1C is a third diagram 100C illustrating a second step in an example administration process shown in FIGS. 1A-1C. In FIG. 1C, the sanitizer component ‘X’ of the liquid chalk composition 102 is allowed to evaporate. After the sanitizer component ‘X’ leaves a coating on the surface 108 of the chalk component ‘T’. In some embodiments, it may take about 30 seconds for the sanitizer component ‘X’ to evaporate.

FIG. 1E is a photograph 100E that is representative of the second diagram 100B and the third diagram 100C shown in FIGS. 1B and 1C, respectively. In FIG. 1E, the liquid chalk composition 102 is applied to and spread on the skin 108 of the hands 110. The liquid chalk composition 102 is not “rubbed into” the skin 108, just spread out. The sanitizer component of the liquid chalk composition 102 is allowed to evaporate, which leaves a coating on the skin 108 of the chalk component. In some embodiments, it may take about 30 seconds for the sanitizer component to evaporate.

In embodiments in which the sanitizer component ‘X’ includes the isopropyl alcohol solution, a cohesive effect may be produced on the skin 108. The cohesive effect may be produced due to the absorption of moisture from the skin 108. The cohesive effect works symbiotically with the chalk compound to increase adherence of the chalk composition ‘T’ to the skin 108. A result of such adherence may include better coverage and longer-lasting effectiveness when compared to powdered chalk or liquid chalks with other liquid components.

In other implementations, the compound may be applied to another surface in a similar fashion. Some examples of the other surfaces may include a bar, a dumbbell, a barbell, another area of the body, gloves, baseball bat, softball bat, golf club, rocks (e.g., during climbing), kettlebells, and wrist straps.

The liquid chalk composition may be stored and/or administered using multiple types of containers. For example, a container for the liquid chalk composition may be a 2-ounce container. The 2-ounce container may include a carabineer used to clip to a gym bag. The 2-ounce container may include a flip top. The 2-ounce container may be portable and/or meet limitations of the TSA.

Another container may be about 4, 8, 16, or 32-ounces. The 4, 8, 16, or 32-ounce containers may be sized to fit into a gym bag, or climbing pack. The 4, 8, 16, or 32-ounce container may include a flip-top.

Another container may include a wall-mounted manual liquid chalk dispenser. The wall-mounted container may be implemented in fitness environments such as gyms and weight rooms. To administer the compound, a button may be pushed by a user on the wall-mounted container. The wall-mounted container may be configured such that a particular amount (e.g., a tablespoon) is dispensed. The wall-mounted container may be physically smaller than chalk buckets and chalk bins. The wall-mounted container may be configured to accept refillable bottles. Additionally or alternatively, the wall-mounted container may be manually operated or electrically operated. For instance, the container may include a motion-sensor that triggers electrical operation.

Another container may be about 32 ounces. The 32-ounce container may be a pump-type container that may be placed on a counter for instance. Like the wall-mounted container, the 32-ounce container may be physically smaller than chalk buckets and chalk bins.

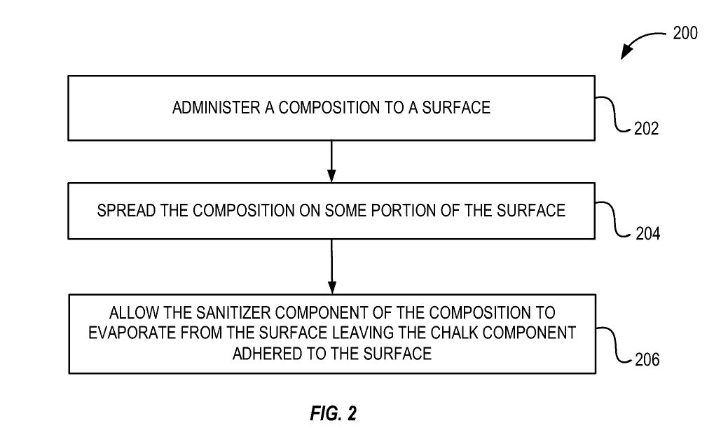

FIG. 2 is a flow diagram of an example method 200 of administering a composition. The method 200 may be implemented by a user to administer a liquid chalk composition to a surface such as skin on the hands of a user as described in this disclosure.

The method 200 may begin at block 202 in which the composition is administered to a surface. The composition may include a mixture of a chalk component and a sanitizer component. The sanitizer component includes an isopropyl alcohol solution with a concentration of isopropyl alcohol (CH₃CH(OH)CH₃) in a range of about 65% to about 75%. The chalk component includes magnesium carbonate (MGCO₃). Additionally, in some embodiments the chalk component ray include a sanitizing agent that includes silver that is added to chalk component during the manufacture of the magnesium carbonate. By adding the sanitizing agent to the chalk component, the sanitizing agent may be evenly or substantially evenly distributed throughout the chalk component.

In some embodiments, the ratio by weight between the chalk component and the sanitizer component is in the range of 1:16 to 1:1, in the range of 1:10 to 1:4, or is about 1:8.

At block 204, the composition may be spread on some portion of the surface. The surface includes skin on a first hand of a user. The spreading the composition may include spreading the composition on some portion of the skin of the first hand and a second hand. The method 200 may further include absorbing moisture with the composition to create a cohesive effect between the skin and the chalk component.

At block 206, the sanitizer component of the composition may be allowed to evaporate from the surface leaving the chalk component adhered to the surface. In some embodiments, the surface includes skin of a user, and the composition further comprises an herbal extract with an anti-germ property and cooling property that creates a cooling sensation when applied to the skin.

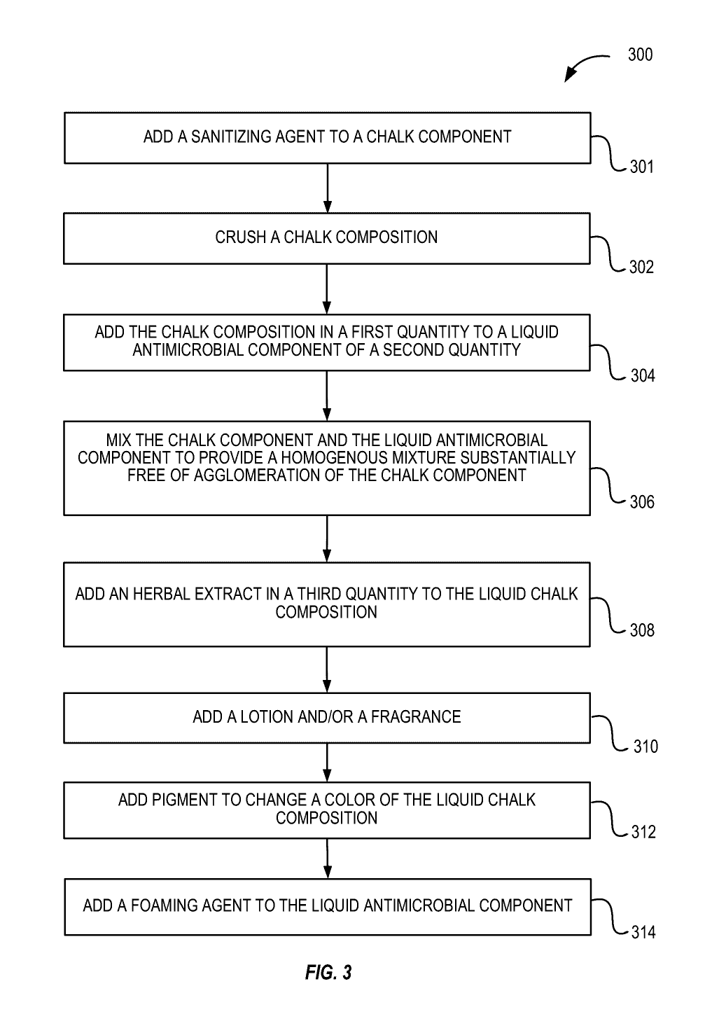

FIG. 3 is a flow diagram of an example method 300 of preparing a liquid chalk composition for application to a surface. The surface may include a bar, a dumbbell, a barbell, a glove, a baseball bat, a softball bat, a golf club, a rock, a kettlebell, a wrist strap, and/or skin of a user. The method 300 may be implemented by a user to prepare a liquid chalk composition such as that described elsewhere in this disclosure.

The method 300 may begin at block 301 in which a sanitizing agent may be added to magnesium carbonate during manufacture. The sanitizing agent may include silver. Adding a sanitizing agent during manufacture may result in the sanitizing agent being substantially evenly distributed in the chalk component.

At block 302 in which a chalk composition is crushed. In some embodiments, the chalk composition may be crushed prior to adding the chalk composition to a liquid antimicrobial component.

At block 304, the chalk composition in a first quantity may be added to the liquid antimicrobial component of a second quantity. The liquid antimicrobial component may exhibit volatility resulting in evaporation of the liquid antimicrobial component following the application to the surface. The liquid antimicrobial component may include an isopropyl alcohol solution with a concentration of isopropyl alcohol in a range of about 65% to about 75%. The second quantity is an amount effective for reducing or eliminating microbes present on the surface following application of the liquid chalk composition to the surface. The liquid antimicrobial component may exhibit moisture absorption properties resulting in production of a cohesive effect upon absorbing moisture for promoting adherence between the composition and the surface. The chalk component is retained in the composition following evaporation of the liquid antimicrobial component. The chalk compound may include magnesium carbonate. The ratio by weight between the chalk component and the liquid antimicrobial component may be about 1:8.

At block 306, the chalk component and the liquid antimicrobial component may be mixed. For example, the chalk component and the liquid antimicrobial component may be mixed to provide a homogenous mixture substantially free of agglomeration of the chalk component. The mixing of the liquid antimicrobial component includes blending the liquid antimicrobial component until the liquid chalk composition has a viscosity that is higher than water.

At block 308, an herbal extract may be added in a third quantity to the liquid chalk composition. The herbal extract may have an antimicrobial property and/or a cooling property that creates a cooling sensation when applied to skin. At block 310, a lotion and/or a fragrance may be added to the liquid chalk composition. At block 312, pigment may be added to change a color of the liquid chalk composition. At block 314, a foaming sanitizer component may be added to the liquid antimicrobial component. The foaming sanitizer component may be added in an amount effective for causing gas entrapment by the liquid chalk composition during application of the composition to the surface.

This disclosure may sometimes illustrate different components contained within, or connected with, different other components. Such depicted architectures are merely exemplary, and many other architectures can be implemented which achieve the same or similar functionality.

The terms used in this disclosure, and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.). In addition, if a specific number of elements is introduced, this may be interpreted to mean at least the recited number, as may be indicated by context (e.g., the bare recitation of “two recitations,” without other modifiers, means at least two recitations, or two or more recitations). As used in this disclosure, any disjunctive word and/or phrase presenting two or more alternative terms should be understood to contemplate the possibilities of including one of the terms, either of the terms, or both terms. For example, the phrase “A or B” will be understood to include the possibilities of “A” or “B” or “A and B.”

The terms and words used are not limited to the bibliographical meanings, but, are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

What is claimed is:

1. A composition, comprising:
a mixture of a chalk component and a sanitizer component,
wherein:
the sanitizer component exhibits volatility resulting in evaporation of the sanitizer component from the composition following application of the composition to a surface; and
the chalk component is retained in the composition following evaporation of the sanitizer component.

2. The composition of claim 1, wherein the volatility results in evaporation of the sanitizer component from the composition in less than about thirty seconds at ambient environmental conditions including about one atmosphere of pressure and about 21 degree Celsius.

3. The composition of claim 1, wherein the sanitizer component exhibits moisture absorption properties resulting in production of a cohesive effect upon absorbing moisture for promoting adherence between the composition and the surface.

4. The composition of claim 3, wherein:
the sanitizer component includes an isopropyl alcohol solution with a concentration of isopropyl alcohol (CH₃CH(OH)CH₃) in a range of about 65% to about 75%; and
the chalk component includes magnesium carbonate (MGCO₃).

5. The composition of claim 4, wherein a ratio by weight between the chalk component and the sanitizer component is in the range of 1:16 to 1:1.

6. The composition of claim 4, wherein the ratio by weight between the chalk component and the sanitizer component is in the range of 1:10 to 1:4.

7. The composition of claim 4, wherein the ratio by weight between the chalk component and the sanitizer component is about 1:8.

8. The composition of claim 4, further comprising an herbal extract exhibiting sanitizing and cooling properties.

9. The composition of claim 8, further comprising a pigment configured to change a color of the composition.

10. The composition of claim 9, wherein:
the concentration of isopropyl alcohol in the isopropyl alcohol solution is about 70%;
the herbal extract is a peppermint extract;
the viscosity of the composition is higher than the viscosity of water; and
the chalk component further includes a sanitizing agent that is added to chalk component during the manufacture of the magnesium carbonate.

11. The composition of claim 9, further comprising a foaming agent configured to trap gas during application of the composition.

12. The composition of claim 1, wherein the surface includes one or more of a bar, a dumbbell, a barbell, a portion of a body of a user, a glove, a baseball bat, a softball bat, a golf club, a rock, a kettlebell, and a wrist strap.

13. A composition, comprising a mixture of:
a chalk component including magnesium carbonate (MGCO₃), a sanitizer component including an isopropyl alcohol solution with a concentration of isopropyl alcohol (CH₃CH(OH)CH₃) in a range of about 65% to about 75%;
an herbal extract; and
a pigment configured to change a color of the composition,
wherein:
the sanitizer component exhibits volatility such that the sanitizer component evaporates following application of the composition to a surface,
the chalk component is retained in the composition following evaporation of the sanitizer component,
the sanitizer component exhibits anti-germ properties in an amount effective for reducing or eliminating germs on the surface to which the composition is applied,
the sanitizer component exhibits moisture absorption properties resulting in production of a cohesive effect upon absorbing moisture for promoting adherence between the composition and the surface, and
the herbal extract includes an anti-germ property that further reduces germs on the surface.

14. The composition of claim 13, wherein:
the surface includes skin of a user; and
the herbal extract creates a cooling sensation when applied to the surface.

15. The composition of claim 13, wherein the volatility results in evaporation of the sanitizer component from the composition in less than about thirty seconds at ambient environmental conditions including about one atmosphere of pressure and about 21 degree Celsius.

16. The composition of claim 13, wherein:
the concentration of the isopropyl alcohol solution is about 70% isopropyl alcohol;
the herbal extract is a peppermint extract;
the viscosity of the composition is higher than the viscosity of water; and
the chalk component further includes a sanitizing agent that includes silver that is added to chalk component during the manufacture of the magnesium carbonate.

17. A method, comprising:
administering a composition to a surface, the composition including a mixture of a chalk component and a sanitizer component;
spreading the composition on some portion of the surface; and
allowing the sanitizer component of the composition to evaporate from the surface leaving the chalk component adhered to the surface.

18. The method of claim 17, wherein:
the surface includes skin on a first hand of a user,
the spreading the composition includes spreading the composition on some portion of the skin of the first hand and a second hand; and
the method further comprises absorbing moisture with the composition to create a cohesive effect between the skin and the chalk component.

19. The method of claim 17, wherein:
the sanitizer component includes an isopropyl alcohol solution with a concentration of isopropyl alcohol (CH₃CH(OH)CH₃) in a range of about 65% to about 75%; and
the chalk component includes magnesium carbonate (MGCO₃).

20. The method of claim 19, wherein the chalk component further includes a sanitizing agent that includes silver that is added to chalk component during the manufacture of the magnesium carbonate.

21. The method of claim 19, wherein:
a ratio by weight between the chalk component and the sanitizer component is in the range of 1:16 to 1:1; or
the ratio by weight between the chalk component and the sanitizer component is in the range of 1:10 to 1:4.

22. The method of claim 19, wherein the ratio by weight between the chalk component and the sanitizer component is about 1:8.

23. The method of claim 19, wherein:
the surface includes skin of a user, and
the composition further comprises an herbal extract with an anti-germ property and cooling property that creates a cooling sensation when applied to the skin.

24. A method of preparing a liquid chalk composition for application to a surface, the method comprising:
adding a chalk composition in a first quantity to a liquid antimicrobial component of a second quantity, wherein:
the liquid antimicrobial component exhibits volatility resulting in evaporation of the liquid antimicrobial component following the application to the surface,
the chalk component is retained in the composition following evaporation of the liquid antimicrobial component,
the second quantity is an amount effective for reducing or eliminating germs present on the surface following application of the liquid chalk composition to the surface; and
mixing the chalk component and the liquid antimicrobial component to provide a homogenous mixture substantially free of agglomeration of the chalk component.

25. The method of claim 24, wherein:
the surface includes skin of a user; and
the liquid antimicrobial component exhibits moisture absorption properties resulting in production of a cohesive effect upon absorbing moisture for promoting adherence between the composition and the surface.

26. The method of claim 25, further comprising adding an herbal extract in a third quantity to the liquid chalk composition, wherein the herbal extract has anti-germ properties and a cooling property that creates a cooling sensation when applied to the skin.

27. The method of claim 24, wherein:
the chalk component includes magnesium carbonate;
a ratio by weight between the chalk component and the sanitizer component is about 1:8; and
the liquid antimicrobial component includes an isopropyl alcohol solution with a concentration of isopropyl alcohol in a range of about 65% to about 75%.

28. The method of claim 27, further comprising during the manufacture of the magnesium carbonate, adding a sanitizing agent that includes silver such that the silver is substantially evenly distributed in the chalk component.

29. The method of claim 27, further comprising:
adding a lotion and/or a fragrance;
adding pigment to change a color of the liquid chalk composition;
prior to adding the chalk composition, crushing the chalk composition; and
adding a foaming agent to the liquid antimicrobial component in an amount effective for causing gas entrapment by the liquid chalk composition during application of the composition to the surface.

30. The method of claim 24, wherein:
mixing the liquid antimicrobial component includes blending the liquid antimicrobial component until the liquid chalk composition has a viscosity that is higher than water; and
the surface includes a bar, a dumbbell, a barbell, a glove, a baseball bat, a softball bat, a golf club, a rock, a kettlebell, and a wrist strap.
